(19) United States
(12) Patent Application Publication
(10) Pub. No.: US 2024/0420126 A1
(43) Pub. Date: Dec. 19, 2024

(54) SYSTEM AND METHOD FOR PROVIDING SECURE TRANSACTION DATA ACCESS TO TRUSTED THIRD PARTIES

(71) Applicant: MobileCoin Inc., dba Sentz Global, Sacramento, CA (US)

(72) Inventors: Sara DRAKELEY, South Lake Tahoe, CA (US); Bob LEE, Miami, FL (US); Henry HOLTZMAN, San Francisco, CA (US); Stark RIEDESEL, Austin, TX (US); Remoun METYAS, San Francisco, CA (US); Geno MOSCETTI, San Francisco, CA (US)

(21) Appl. No.: 18/744,475

(22) Filed: Jun. 14, 2024

Related U.S. Application Data
(60) Provisional application No. 63/521,215, filed on Jun. 15, 2023.

(51) Int. Cl. G06Q 20/38

(52) U.S. Cl. CPC G06Q 20/3829; G06Q 2220/00

(57) ABSTRACT

A system and method for providing secure transaction data access to trusted third parties are disclosed. An example embodiment is configured to: establish a data connection between a user platform including a data processor and a network connection, a digital exchange blockchain for storage and processing of digital assets using a consensus network protocol, and a Trusted Transparent Transaction (T3) service provider; provision a key for use by an institution to access transaction data collected by the T3 service provider; collect transaction data associated with a digital asset transfer transaction between the user platform and the blockchain; store the transaction data in a database; and enable the institution to access the transaction data by use of the provisioned key.

### PRIORITY PATENT APPLICATION

This patent application is a non-provisional U.S. patent application drawing priority from U.S. provisional patent application Ser. No. 63/521,215; filed Jun. 15, 2023. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2022-2024, MobileCoin Inc.™, dba Sentz Global™, All Rights Reserved.

### TECHNICAL FIELD

This patent document pertains generally to secure transaction networks, online value transfer systems, secure cryptocurrency exchanges, digital asset management, and more particularly, but not by way of limitation, to a system and method for providing secure transaction data access to trusted third parties.

### BACKGROUND

Various institutions, such as banks and other financial institutions, law enforcement, and government monetary policy makers often require access to the details of financial transactions to monitor and verify the validity, accuracy, and legality of these transactions. Digital asset transfers and cryptocurrency exchange transactions, which can be obfuscated behind layers of encryption, can be inaccessible to these institutions, thereby hampering their ability to monitor and verify these transactions. Conventional solutions and systems have been unable to provide a way to support institutions' compliance programs by delivering secure transparent details about transactions involving those institutions.

### SUMMARY

A system and method for providing secure transaction data access to trusted third parties are disclosed. In the various example embodiments disclosed herein, the Trusted Transparent Transaction (T3) system of an example embodiment enables clients and institutions to provide necessary transaction data optionally and securely for institutional compliance to trusted third parties. The various example embodiments disclosed herein provide a service where clients opt-in to store transparent transaction data when they send any asset on a digital exchange blockchain which otherwise has encryption properties, and where institutions opt-in to store data when they send a transaction to a user. In practice, this results in encrypted peer-to-peer PrivatePay™ transactions, with transparent T3 transactions when users interact with institutions or when otherwise provided by the user or their wallet service. This service is managed by Sentz Global™ (aka Sentz™), or other T3 service provider, and offers read and write access to institutions who provision an Application Programming Interface (API) key with Sentz™ or other T3 service provider. In an example embodiment, a digital exchange blockchain can be used for storage and processing of digital assets using a consensus network protocol and decentralized ledger technology.

The various example embodiments disclosed herein are not limited to cryptocurrencies that make use of SGX, the Stellar Consensus Protocol algorithm, or those that implement parts of the CryptoNote protocol. SGX is an Intel@ Corporation Software Guard Extensions (SGX) architecture. SGX is a set of central processing unit instruction code from Intel@ that allows user-level code to allocate private regions of memory, called enclaves, which are protected from processes running at higher privilege levels. The Stellar Consensus Protocol (SCP) provides a way to reach consensus in a secure financial transaction without relying on a closed system to accurately record financial transactions. CryptoNote is an application layer protocol that aims to solve the problems outlined in Bitcoin™ Core, the protocol behind Bitcoin™. The protocol powers several decentralized privacy-oriented cryptocurrencies.

The various example embodiments disclosed herein provide a combination of encrypted blockchain-accessible digital assets plus additional transparent compliant tooling, which can be used to provide transparent T3 transactions when users interact with institutions or when otherwise provided by the user or their wallet service. This combination of encrypted blockchain and transparent T3 transactions comprises the T3 technology disclosed herein. In addition, the disclosed example embodiments provide additional functionality for payments, not just in blockchain, taking the self-custody, decentralization, and end-to-end encryption (E2EE) and pairing these features with compliance tools, technologies, and processes to create a unique T3 transaction and payment technology. Several of the features and advantages realized by the disclosed example embodiments are listed below.

### Encrypted Blockchain+Trusted Transparency

Transactions are direct between counterparties (no intermediaries).
Transactions have encryption and data protection at the protocol layer.
Users custody their funds AND their data-no custodian.
Users opt-in to share data to T3 by using different aspects of the service.
   (Unlike in traditional finance, where the only way to opt out of sharing data is to use cash, forcing users to manage two entirely different asset types: physical dollar bills and digital dollars in a bank or fintech app).
   For example, by using ramps or sending a payment request, a user opts in to share data.
Users can configure data sharing for some aspects of the app (e.g., do not share metrics), but cannot opt out of other data sharing (for example, every time they use a ramp who is opting in to T3, their data is shared to T3). The content of this data are defined by the T3 service as detailed herein.
Users are aware of when data is being shared with T3 or not (e.g., through PrivatePay™ denoted in the user interface).
Data is available to ecosystem participants who are provisioned an API key.
   Institutions such as ramp providers, exchanges, or forensics providers.
   The business may establish the terms around this data (whether it can be shared or sold) through the terms of the agreement with these ramps providers.
T3 data is directly tied to public, decentralized transaction data on the blockchain
   This is in contrast to credit card or fintech data, which does not have the robustness, longevity, or verifiability of decentralized ledger technology.
T3 is extensible and decentralizable-different wallet providers may wish to configure transparent data differently.
   For example, Mastercard™ may wish to run a T3 instance for their customers, and to not share the data with other participants. They may also wish to develop a white-labeled wallet which shares additional data about the customer. Mastercard™ may also wish to then sell that data. The customer has a choice to use the Mastercard™ wallet with its terms and services, or to select a wallet which makes a different set of commitments to the customer, while still experiencing portability of their assets through the self-custody aspect of blockchain. They can take the same funds seamlessly from a Mastercard™ wallet to a Sentz™ wallet (or other wallet service provider), or even to a wallet that they create from scratch, using the open source transaction libraries and public cryptography algorithms.
T3 Data seamlessly fits into data forensics providers APIs and architecture. In blockchain, a need for “chain forensics” emerged as part of overall compliance and fraud-prevention business needs. Providers such as Elliptic™, Chainalysis™, and TRM™ evaluate both on and off-chain data to provide a risk score to financial institutions on given transactions or users. T3 enables the first ever integration with forensics providers to support on-chain encrypted transactions.

The systems and methods of example embodiments are described in more detail below with reference to the figures provided herewith.

### BRIEF DESCRIPTION OF THE DRAWINGS

The various embodiments are illustrated by way of example, and not by way of limitation, in the figures of the accompanying drawings in which:

FIG. 1 illustrates an example embodiment showing a sample transaction between various parties;

FIG. 2 illustrates an example embodiment showing screenshots from the user interface of a mobile device for a sample transaction between various parties;

FIG. 3 illustrates an example embodiment of Institution Offramping;

FIG. 4 illustrates an example embodiment of Institution Onramping;

FIG. 5 illustrates the T3 data format for an example embodiment;

FIG. 6 illustrates an example where transaction amounts may not be equal;

FIG. 7 illustrates an overview of the system architecture of an example embodiment;

FIG. 8 illustrates an example of Offramp: Store & Query Institutional Transaction Data;

FIG. 9 illustrates an example of Onramp: Store & Query Institutional Transaction Data;

FIG. 10 illustrates an example of the use of the Recoverable Transaction History data;

FIG. 11 illustrates an example of a Sentz™ T3 Graph;

FIG. 12 illustrates an example of a Sentz™ PrivatePay Transaction Graph;

FIG. 13 illustrates an example of a Goal: A Hybrid Chain with PrivatePay+T3.

FIG. 14 illustrates an overview of the system architecture of an example embodiment; and

FIG. 15 is a processing flow diagram that illustrates an example embodiment of a system and method as described herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for providing secure transaction data access to trusted third parties are disclosed. In the various example embodiments disclosed herein, the Trusted Transparent Transaction (T3) system of an example embodiment enables clients and institutions to provide necessary transaction data optionally and securely for institutional compliance to trusted third parties. The various example embodiments disclosed herein provide a service where clients opt-in to store transparent transaction data when they send any asset on a digital exchange blockchain to an institution, and where institutions opt-in to store data when they send a transaction to a user. In practice, this results in encrypted peer-to-peer PrivatePay™ transactions, with T3 transactions at onramps and offramps or when otherwise provided by the user or their wallet service. This service is managed by Sentz™, or other T3 service provider, and it is also generalized in that any payment service provider or wallet may opt-in to submit transactions to their own instance of T3, similar to how Visa™ and Mastercard™ manage private databases of their users' transaction data, and offers read and write access to institutions who provision an Application Programming Interface (API) key with Sentz™ or other T3 service provider.

A full disclosure of a particular embodiment using a secure transaction network and Merkle proofs is described in MobileCoin Inc.™ U.S. patent applications with application Ser. No. 16/213,956, filed Dec. 7, 2018 and titled, “SYSTEM AND METHOD FOR PROVIDING A SECURE TRANSACTION NETWORK”; and application Ser. No. 16/570,675, filed Sep. 13, 2019 and titled, “SYSTEM AND METHOD FOR PROVIDING PRIVACY-PRESERVING PROOFS OF MEMBERSHIP.” The entire disclosure of the referenced patent applications is considered part of the disclosure of the present application and is hereby incorporated by reference herein in its entirety.

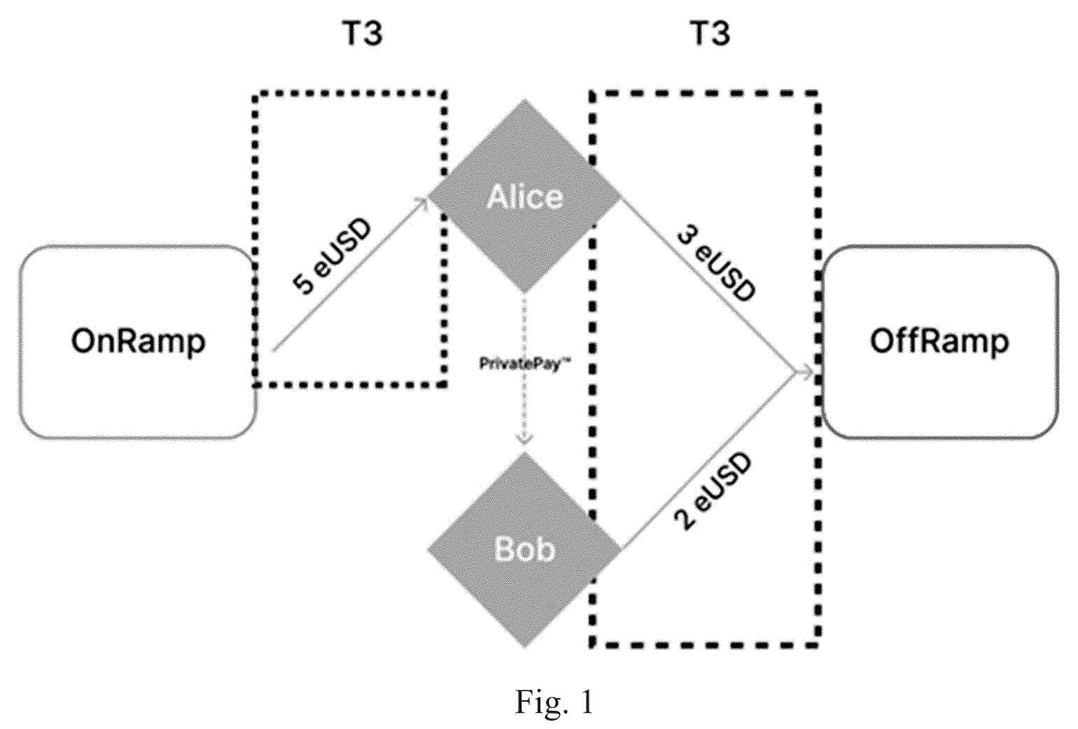

FIG. 1 illustrates an example embodiment showing a sample transaction between various parties. As disclosed herein, the term “digital assets” refers to a unit of a digital asset, such as a MobileCoin™ or Sentz™ asset, MOB, eUSD, or other digital asset on the Sentz™ (or other service provider) blockchain. As disclosed herein, the term “Offramping” or “depositing digital assets” (from a financial institution's perspective) involves a user exchanging their digital assets for Fiat (or other crypto). Fiat money is a type of currency that is not backed by a commodity, such as gold or silver. It is typically designated by an issuing government entity to be legal tender. As disclosed herein, the term “Onramping” or “withdrawing digital assets” (from a financial institution's perspective) involves a user exchanging their Fiat (or other crypto) for digital assets. As disclosed herein, the term “Sentz™” refers to a software application or app provided by Sentz™ and featuring the PrivatePay™ shielded, non-transparent, transaction functionality. The Sentz™ app provides wallet functionality to enable a user to manage digital assets or cryptocurrency. Other terms used herein are defined in the Glossary at the end of this document.

As shown in FIG. 1:
1. An Onramp provider sends a first sample party (e.g., Alice) 5 digital asset units (in a transparent transaction).
2. Alice sends a second sample party (e.g., Bob) 2 digital asset units (in a PrivatePay™ shielded, non-transparent transaction).
3. Alice sends an Offramp Provider 3 digital asset units minus fees (in a transparent transaction).
4. Bob sends the Offramp Provider 2 digital asset units minus fees (in a transparent transaction).

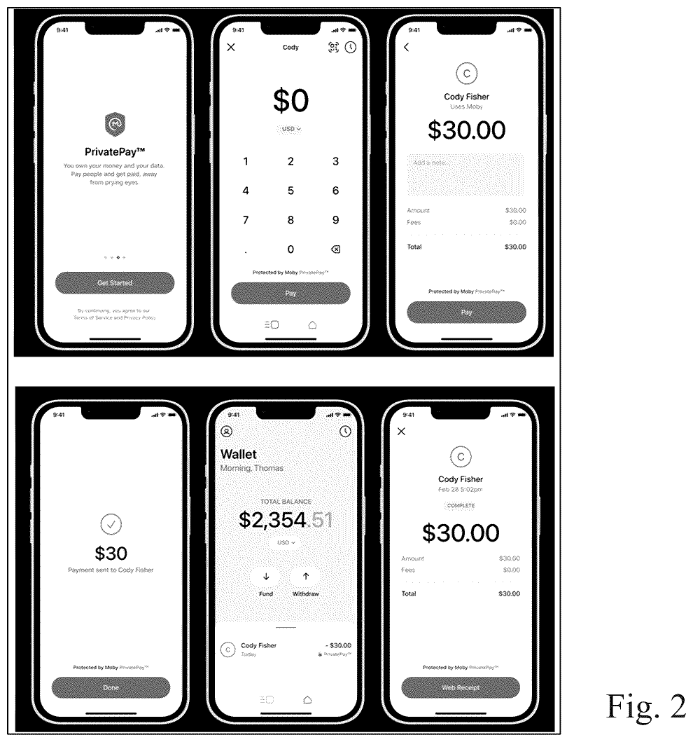

FIG. 2 illustrates an example embodiment showing screenshots from the user interface of a mobile device for a sample transaction between various parties.

For the various example embodiments disclosed herein, several technical design tenets are followed:
1. PrivatePay™ transactions will not be impacted by this design. No data from PrivatePay™ transactions will be stored in T3 and privacy will not be degraded for peer-to-peer transactions.
   a. We maintain the threat model that an SGX enclave exploit reveals a portion of the transaction graph during which statistical analysis could be performed on the inputs.
   b. We will protect users from degrading their privacy in the event of an SGX exploit by allowing them to opt-out of using public decoy inputs, and we will improve our solution for this over time, while communicating the threat model and roadmap to users.
      i. We will start with the lightest lift, understanding that we can publish the T3 public keys at any time, for example, as a bloom filter that clients can query to exclude public TxOuts from their rings.
2. T3 Transactions are opt-in on send, but anyone can receive a T3 transaction at their usual public address. There is no technical barrier to receiving a T3 transaction.
   a. To enable “opt-in” before receiving, we can have a pre-negotiated credential from the receiver that T3 validated upon the sender's submission.
3. Users will not necessarily need to maintain two addresses or two balances.
4. T3 Transactions are discernible from on-chain data on the TxOut.
   a. This prevents wallets from checking with the T3 database for every TxOut to display whether it is PrivatePay™
   b. This allows wallets not associated with Sentz™ to incorporate ring selection strategies with the knowledge of the private/public quality of a TxOut.
5. We provide an API for third parties that is similar to existing industry standards around blockchain forensics.
6. Institutional access to T3 is permissioned by Sentz™, or whichever entity is operating a T3 service, with API Key access and permissions managed with best practices to approve and revoke privileges, and properly communicate privilege status with appropriate transparency.
7. The data included in a T3 entry is configurable, and an example embodiment includes a hash of the sender address, a hash of the receiver address, the amount in plain text, the token type, and the txo_public key that links the transaction to the public blockchain. With this data, forensics providers may analyze T3 activity and provide risk scoring. In this way, a user is incentivized to build up their T3 profile similar to how credit card users are incentivized to build up a credit score through transactions and payments.
8. Institutions opt-in to construct all of their retail transactions with KYCed [Know Your Customer-identity-verified] customers as T3 transitions.
a. It is not necessary for institutions to change themselves, or transactions at the business level, such as managing their cold/hot wallets, or with LPs [Liquidity Providers])
9. The T3 provider is not required to maintain a registry of addresses for institutions. Institutions can choose to provide a single address hash for all their transactions, they can choose to provide a different address hash for every transaction, or per user. It is up to them, and blockchain forensics firms use the tools they have already developed to understand on-chain address data.
10. Institutions understand that they need to change their onboarding flow to collect the address from the user that will be included in the sender memo if they want to be able to correlate that address with the user and authenticate the memo.

### How Blockchain Analytics and Risk Models Are Accomplished Today

In public blockchains, licensed institutions can understand the sender, receiver, and amount of every transaction. This data helps them maintain their compliance and anti-fraud programs, to provide Suspicious Activity Reports (SARs) in strict regulatory environments, or to comply with regulations such as the Travel Rule. Blockchain analytics providers ingest this data and apply their own risk models to help institutions determine risk assessments of sending or receiving funds from users on their platforms.

In Sentz™, users may be directed to interact with institutions that have requirements around reporting suspicious activity, through those institutions' widgets, portals, or though APIs, or the users may interact directly with the institution and provide the wallet address from Sentz™. Due to the self-custodial nature of blockchains and cryptocurrency, the user may not be able to directly provide all aspects of a transaction that the institution requires for their anti-fraud and compliance programs. This is because the blockchain does not provide a mechanism for users to opt in to sharing the data necessary for those institutions without otherwise making that data public to network participants other than the institution, or even worse, some chains force the user to provide spend authority over their funds by revealing their private keys in order to provide more information about the transaction.

In Zcash™, users have the option of using a shielded or a transparent address, and several institutions are then able to accept transactions from transparent addresses who wouldn't otherwise from shielded addresses, or institutions can choose to only deposit to transparent addresses. The downside is that the transparent addresses are public to all, whether it be trusted third parties, foreign governments, or criminals (e.g., stalkers, thieves, kidnappers, foreign spies, et. al.). In addition, it adds complexity to the wallet, by either requiring users to maintain two wallets, with two balances, and for the wallets to expose these concepts to the user with a complex UX [User Experience], or by requiring the wallet to do consolidating transactions in the background to send funds between the shielded or transparent addresses, which incurs a blockchain fee for which the end customer is responsible.

### Technical Description of an Example Embodiment of T3

In various example embodiments disclosed herein, Sentz™ clients and institutions submit Trusted Transparent Transactions (T3) to a database that can be queried by trusted third parties. The processing and handling of these T3 transactions are described in more detail below.

### Sending Digital Assets to an Institution (“Offramping”)

Offramping, or “depositing digital assets” involves a user exchanging their digital assets for Fiat (or other crypto). Some institutions have requirements related to risk analysis on the “Source of Funds” in these cases. The existing solution for institutions is to provide a unique subaddress to the user in order to be certain the source of funds is that user. In addition, the Authenticated Sender Memo provides cryptographic proof that the counterparty who sent the transaction owned the private keys associated with their public address, which can then be verified by the institution.

T3 enhances the Source of Funds risk assessment by providing blockchain analytics firms additional data about the sender if that user has established a history of T3 transactions. On the first deposit, there is no new information to the institution, as the offramp provider already knows the sender (from subaddresses and the authenticated sender memo), the receiver (themselves), and the amount.

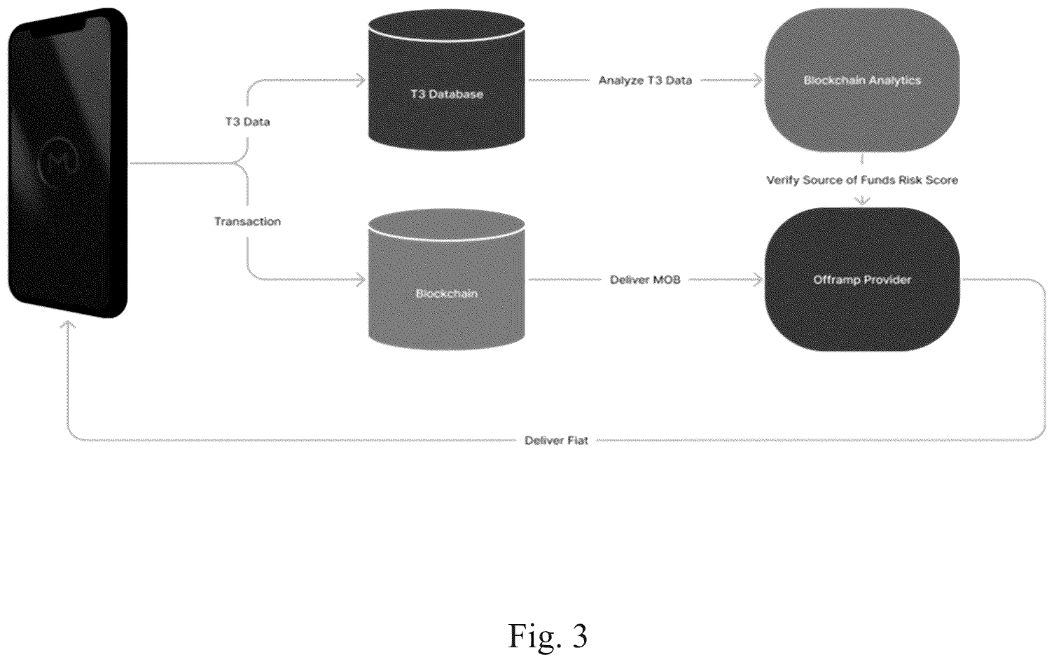

FIG. 3 illustrates an example embodiment of Institution Offramping. As shown in FIG. 3:
1. User completes KYC with the Offramp Provider and establishes an account (Not shown).
2. User receives a unique subaddress from the Offramp Provider institution at which to deposit funds (Not shown).
3. User sends the transaction to the blockchain and T3 data to the T3 service.
4. Analytics provider assesses risk score of the sender.
5. Offramp provider verifies the blockchain funds were sent by the sender in the T3 database.
6. Offramp provider delivers Fiat to the user.

Note, if the sender is determined to have an unacceptable risk score, the institution must determine what to do with the funds that they received. For example, the institution may decide not to provide a deposit address to a customer until the risk score has been assessed (this can be done automatically through APIs and may take only seconds), or they may decide to receive funds into their platform, but not release them to the user until, for example, more KYC data can be provided through their interface.

Receiving Digital Assets from an Institution (“Onramping”)

Onramping, or “withdrawing digital assets” involves a user exchanging their Fiat (or other crypto) for digital assets. Some institutions have requirements around the risk analysis on delivering digital assets to their users. Coinbase™, for example, only delivers Zcash™ to transparent addresses. Gemini™ used to only deliver Zcash™ to transparent addresses, but in 2020 added the capability for shielded withdrawals, illustrating how institutions need the ability to manage their risk while serving customers' needs to have control of their data.

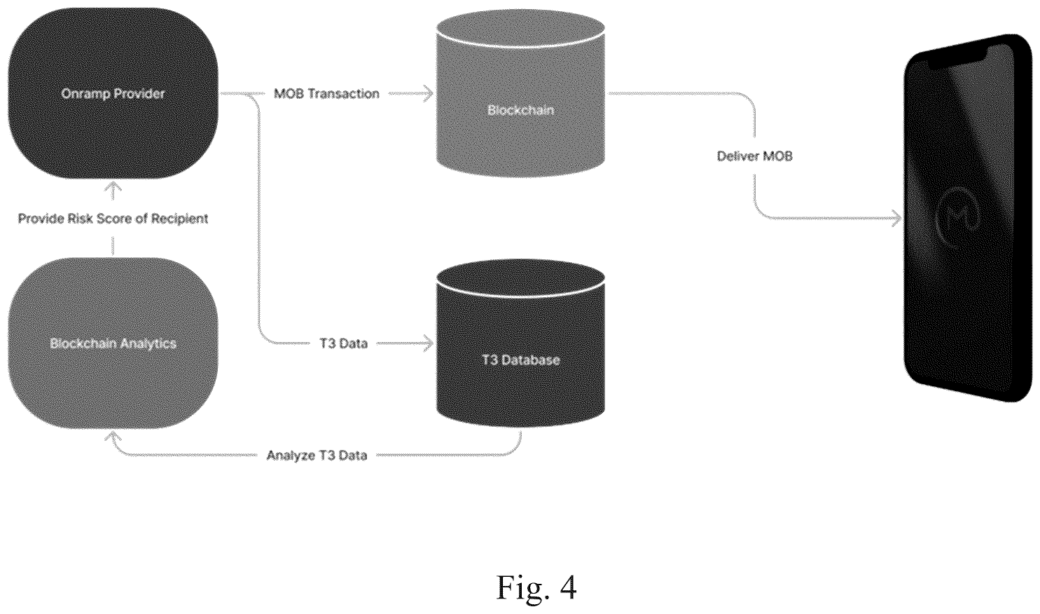

FIG. 4 illustrates an example embodiment of Institution Onramping. As shown in FIG. 4:
1. User completes KYC with the Onramp Provider (Not shown).
2. User deposits the amount of fiat or crypto they want to convert to digital asset (Not shown).
3. User provides their digital asset address to the onramp provider (Not shown).
4. Onramp provider checks the risk score of the User's address.
5. Onramp provider sends digital assets to the user via the blockchain, and provides T3 data on the transaction to the T3 service.

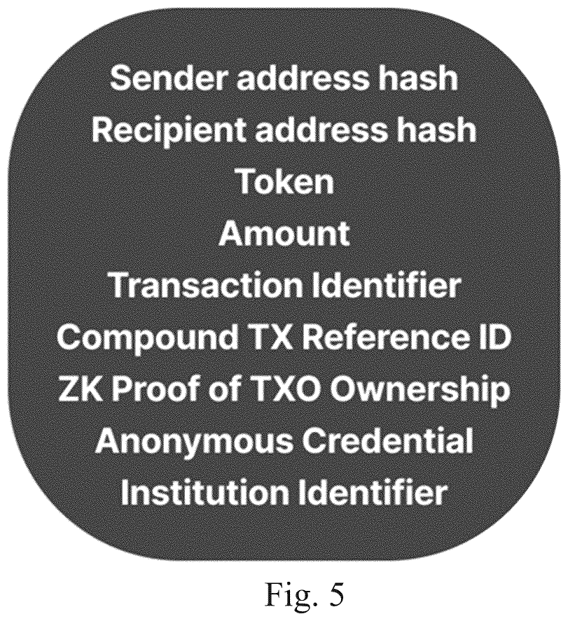

FIG. 5 illustrates the T3 data format for an example embodiment. For onramping, offramping, peer-to-peer, or any other transactions, the T3 data format is the same. In example embodiments, T3 can be extended to any type of transaction that the wallet would like to report. For example, T3 can support reporting a transaction post-fact, in order to enable users to increase the data available for a risk score, or if a customer would like to report a transaction they felt was suspicious.

### Sender and Recipient Address Hashes

We send a hash of the address rather than the address itself because while the public address is “public” in nature, it can be identified with personal information, and if the institution has performed onboarding for the counterparty, they will already have the user's public address data. In addition, services that scrape public addresses for banned lists will be able to hash those addresses to cross-references with the hashes in the T3 data. From a different perspective, an example embodiment adds an additional layer of permissioning. That is, in order to understand the source or recipient of funds, you need to have access to their public address. Note, this does not preclude the tooling that blockchain forensic providers offer; because, even without having access to all public addresses, their statistical analysis techniques can provide risk scores for activity that behaves fraudulently, which the institution can then cross reference with the public address data that they have on hand for their customers. Alternatively, the institution may provide their database of addresses directly to the forensic provider-something they already do in many cases.

### Token and Amount

The amount and token/currency (MOB, eUSD, or in any digital asset's denomination) of the transaction is necessary for risk scoring analytics, and helps to confirm the T3 data matches the on-chain data.

In an example embodiment, we start with the currency in the clear, so that when we start supporting multiple assets including other Fiat stablecoins, we do not need to do multiple conversions in order to get the instantaneous value of the original transaction (e.g., the user transacted in eEUR, but we stored in eUSD at the time, and to get the equivalent eEUR, we would need to look up the USD-> EUR conversion rate at that moment in time). An alternative is to store the instantaneous USD conversion value (or other common conversion valuation) of the amount of the transaction, whether it is MOB or eUSD, or another asset. The reason to do this is both to preserve the confidentiality of the token type, and to provide the preferred information (USD value) more easily to institutions. Note, this is easily configurable per instance of T3, and these fields can also be expanded to include various schemas for historical value logging.

Pass through likability is possible with public amounts. This is when PrivatePay™ transactions accidentally degrade privacy by interacting with T3 transactions while using similar amounts. This cannot be addressed at the protocol level, and is one of the motivations behind the trusted nature of T3.

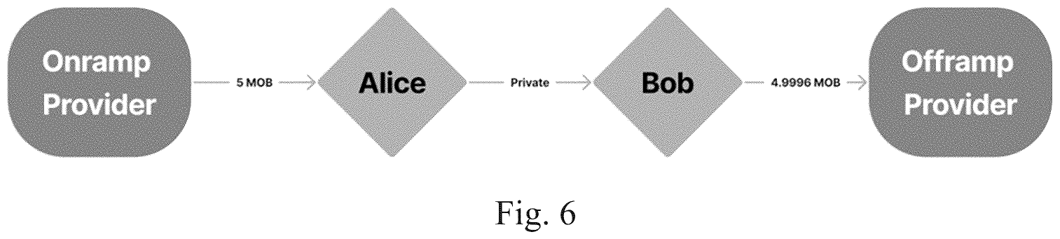

An example is illustrated in FIG. 6 where transaction amounts may not be equal. As shown in FIG. 6, it is likely that Alice withdrew 5 digital asset units to pay Bob, who deposited that same 5 digital asset units (minus the fees) to the offramp provider.

### Transaction Identifier

T3 stores the tx_pubkey of the transaction output, which is the only guaranteed-unique identifier for TxOuts on the blockchain, and is used to verify transactions between counterparties with the public block explorer, and as a reference in transaction history. The tx_pubkey is cryptographically associated with both sender and receiver data as well as unique transaction data (the tx_privkey), as it is the random value generated as part of the CryptoNote protocol. Institutions typically query T3 by tx_pubkey on deposits, to confirm the source of funds on the TxOut they received.

The following are examples of optional data that can be configured to be stored with a T3 instance.

### Compound TX Reference ID

For some transactions, a compound entry may be appropriate, linking multiple transactions to each other as part of an overall “compound transaction.”

### ZK Proof of TXO Ownership

A zero knowledge proof linking the contents of the T3 entry to the sender of the transaction that can be verified with the blockchain data or the sender or receiver's public address.

### Anonymous Credential(s)

A type of digital credential that allows the sender or receiver to authenticate their identity or other metadata without compromising their privacy.

### Institution Identifier

For T3 entries submitted by institutions, an identifier associates the writer of the data with their permissioned API key.

### Authenticating and Verifying T3 Data-Authentication Architecture

Users can authenticate with their phone number to the identity service, to write T3 data. (Note, end users of wallets such as Sentz™ do not need to read T3 data for their own transactions, as they already can determine the sender, receiver, and amount from the TxOut and transaction history stored both on the blockchain as well as with the wallet service backend).

Institutions can authenticate with an API key provisioned by Sentz™, to both write and read T3 data. In general, T3 follows best practices for authentication. Nevertheless, it is important to distinguish authentication for wallets that are authoring data on behalf of institutions versus end-customers. In fact, because data can be written from both sides of the transaction, (e.g., the wallet writes data as a sender, the institutions write the same transaction as a receiver, both with the same public key), greater adoption by institutions helps to amplify the validation of T3 data and risk scoring with respect to forensics.

### Authenticated Data

The on-chain transaction data itself contains a Hash-Based Message Authentication Code (HMAC) for authentication, in the Recoverable Transaction History's authenticated sender memo. The key for the HMAC is the TxOut's shared secret, as this key is derived from the Sender's and the Recipient's keypairs, and can be recreated by either the sender or receiver. Only the receiver can verify the sender memo authentication, and institutions are expected to do this when receiving deposits, to create a SAR if the sender memo cannot be authenticated.

We can optionally request institutions to report back to T3 if they create a SAR when a sender memo cannot be authenticated. In an example embodiment, we can also establish a consortium for data sharing between all T3 institutions and may need to include this in contract negotiations with them. The institution may also choose not to share data with other institutions for competitive advantage (e.g. to not leak business performance through volume numbers), and only intermediate the data through a blockchain forensics provider. With a public blockchain, an institution has no choice but to publicly disclose usage and volume statistics by operating on chain.

### Zero Knowledge Proof of Transaction Construction

In an example embodiment, we may add a zk proof or anonymous credentials to verify that the private keys that constructed the transaction are owned by the same person who submitted the transaction to T3. In this example embodiment, the authentication to write data to T3 is managed at the application layer, via authenticating the phone number or email and providing an access token to be included in subsequent request headers. The authenticated sender memo in the TxOut on chain provides an additional layer of security because the HMAC could only have been created by someone who controlled the private keys of an address to complete a Diffie-Hellman key exchange with the recipient's public key, which must match the address the recipient has on file for the sender. We ensure that the memo doesn't end up being deterministic to avoid possible linkages using a signature

### T3 and Subaddresses

In an example embodiment, T3 can work seamlessly with multiple layers of compliance tooling. For example, we recommend that institutions utilize subaddresses, in order to assign a specific address to a customer and ensure that funds received were from that specific counterparty. In reporting to T3, the institution may choose to report the subaddress as the recipient address, or to report another address they control (for example, to provide a singular address for all institution activity). The sender will report the subaddress to T3 from the sender-side T3 entry, and the forensics provider or the institution can cross-reference these entries with the singular institution address to gain a more robust transaction graph. Alternatively, the institution may choose to report the subaddress, so as not to link all of their transactions beyond the API key presented when writing the data.

### Displaying T3 Data

Wallets may choose how to display transactions to indicate to the end customer whether a transaction's data is shared with trusted institutions. For example, Sentz™ displays T3 transactions and PrivatePay™ transactions interleaved in Transaction History. To determine whether a transaction is T3, the client checks the TxOut's sender or destination memo.
1. If the data received was T3, this is derivable from the sender memo, and the client updates the transaction history entry with T3=true after decrypting the sender memo.
2. If the data sent was T3, the client stored t3=true in the transaction history data, and can also recover this from the Destination memo on the change.

### Detailed Architecture of an Example Embodiment

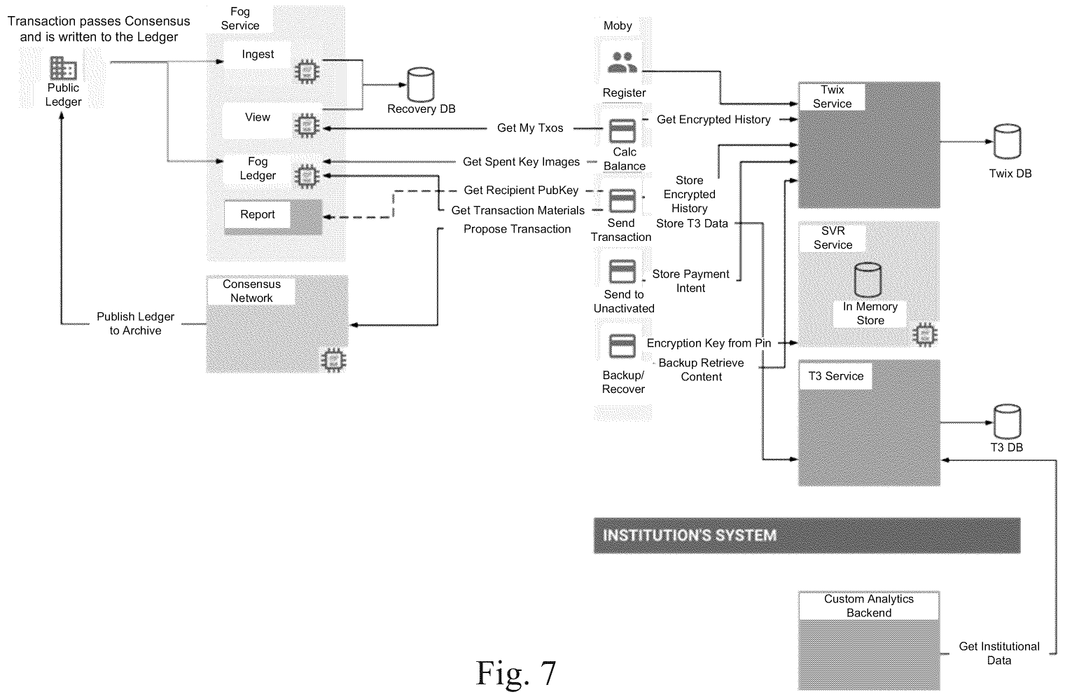

In an example embodiment, we add a new microservice to the system architecture that handles receiving data from clients, and servicing requests to trusted third parties via an API-gated endpoint. The API key will be provisioned and managed by Sentz™ or other T3 service provider. An overview of the system architecture is illustrated in FIG. 7.

### Sequence Diagrams

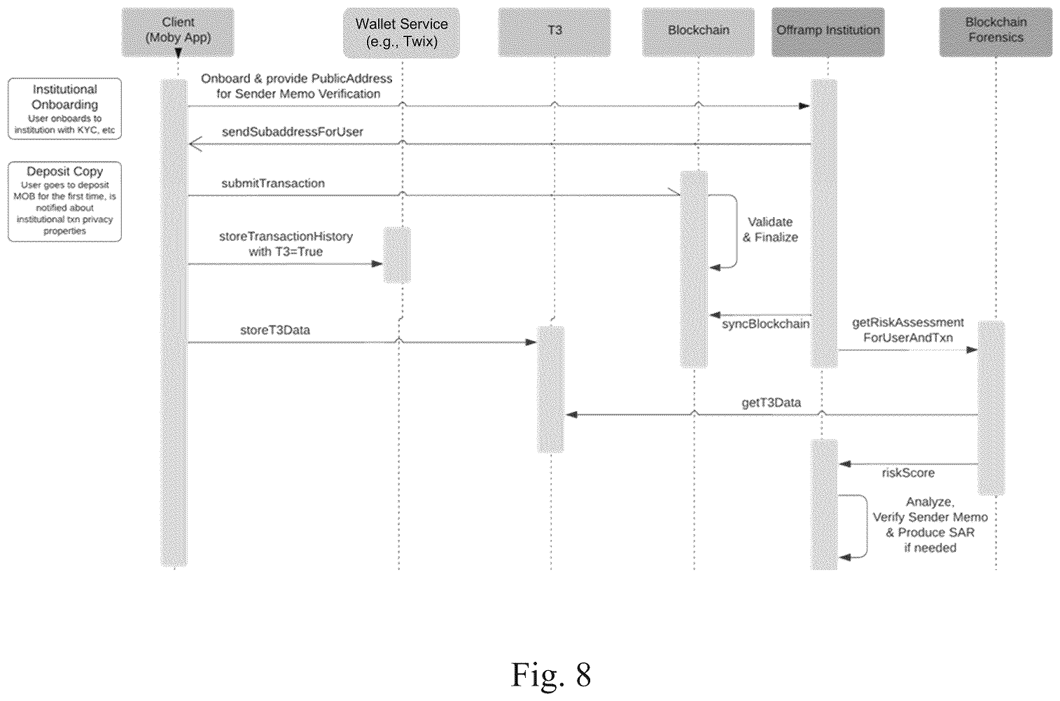

FIG. 8 illustrates an example of Offramp: Store & Query Institutional Transaction Data functionality provided by an example embodiment.

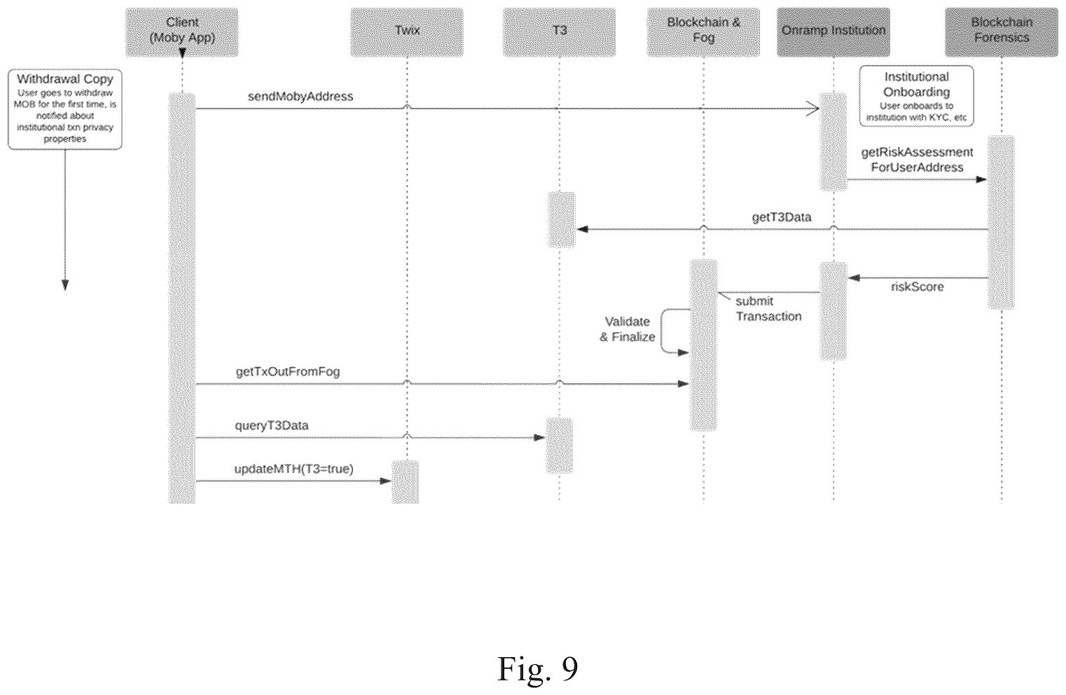

FIG. 9 illustrates an example of Onramp: Store & Query Institutional Transaction Data functionality provided by an example embodiment.

### Recoverable Transaction History Refresher

We would like to leverage the Recoverable Transaction History data where a sender opts in to including data about the sender and receiver of a transaction as metadata in the UTXO. Note that Peer-to-Peer transactions do not need to report any data to T3 and can leverage PrivatePay™.

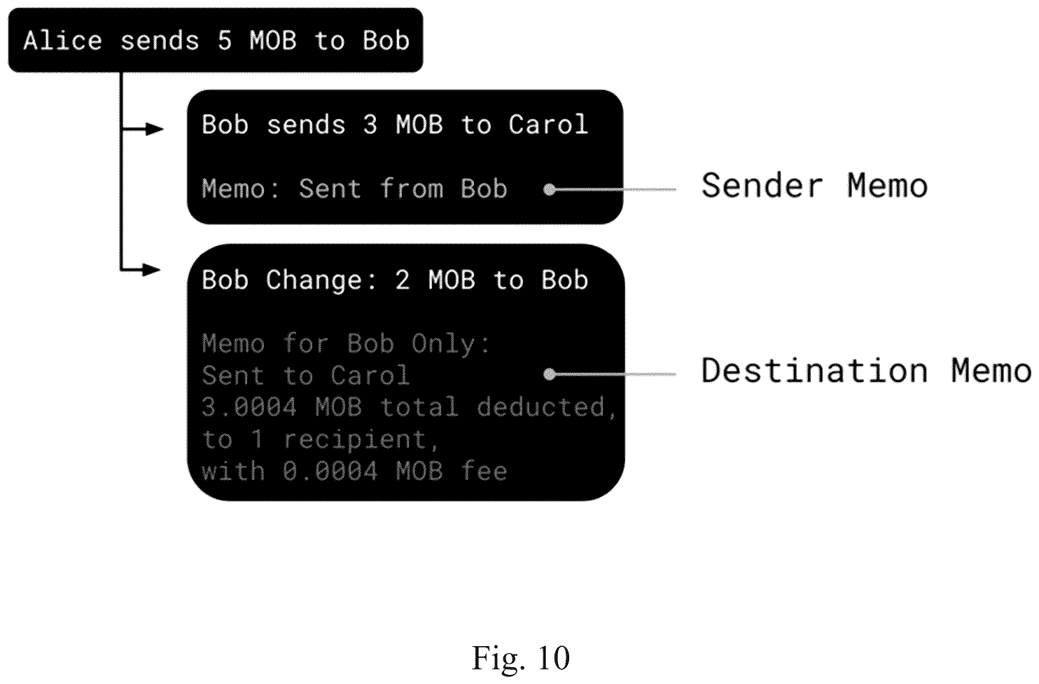

FIG. 10 illustrates an example of the use of the Recoverable Transaction History data. In the example shown, the memos are encrypted with the TxOut shared secret, which is something the receiver derives from their private view key and the TxOut, and the sender knows at the time of construction.

A brief refresher on the transaction math around the TxOut shared secret is provided next. The sender creates the onetime address for the TxOut from the recipient's public address (note all public/private refer to the recipient's keys unless otherwise specified, with_i meaning “at subaddress i”):

// Establish the TxOut Private Key (r)
r = random( ) // This value cannot be recreated and must be stored by the sender.
// Determine onetime address (aka target_key) and tx_public_key, public fields on the
Txout onetime_address = hash_to_scalar(r * public_view_1) * Generator + public_spend_1
tx_public_key = r * public_spend_at_subaddress_i

When the receiver view key scans, they perform this operation:

// Attempt to derive the TxOut Private Key (r), and the public_spend
r = private_view * tx_public_key / public_view_i // Because public_view_i =
private_view * public_spend_i derived_public_spend =
onetime_address − hash_to_scalar(r * public_view_i) * Generator

If the derived_public_spend matches the recipient's public_spend_i, then they know the output is addressed to them. As both the sender and the receiver have the TxOut Private Key (r), they can both create the tx_out_shared_secret, which is shared_secret=r * view_public_i.

The TxOut Private Key (r) is ephemeral, and the sender only has it on creation. They cannot recover it from the blockchain. Therefore, they cannot read the “sender memo” on the Sender Memo unless they store the TxOut Private Key or the TxOut Shared Secret (which some of our wallets do). The sender does not need to read the Sender Memo on the recipient's output, however, because they have all the information they need on the Destination Memo.

The destination memo is recoverable by the sender because it is encrypted with a TxOut Shared Secret that the sender derives from view-key scanning the change TxOut. This memo is not viewable by the recipient.

The Destination Memo only supports specifying a single recipient, though some wallet operations prefer multiple recipients. These will not be recoverable from this scheme, and will not be visible in the T3 database.

The sender memo is authenticated with an HMAC whose key is derived from the Sender's and the Recipient's keypairs, as shown below:

(sender_private_spend_key_j * recipient_public_view_key_i)*G =
(sender_public_spend_key_j * recipient_private_view_key_1)*G

The benefit of using the TxOut shared secret for the encryption of the memo and the Diffie-Hellman key exchange secret for the HMAC is that the recipient can be certain the Sender memo was created by whoever had the authority to spend the TxOut and create the TxOut Private Key.

### Trusted Transparent Transaction (T3) Transform

In order to persist a new transaction type to the Trusted Transparent database, we need a way to convert a Sentz™ transaction to an Institutional Transaction. What follows is an outline of what this transformation looks like.

### Transaction Graph Examples

A Sentz™ input has multiple potential inputs. We do not want to reveal the “real” input, unless it is also a transparent input.

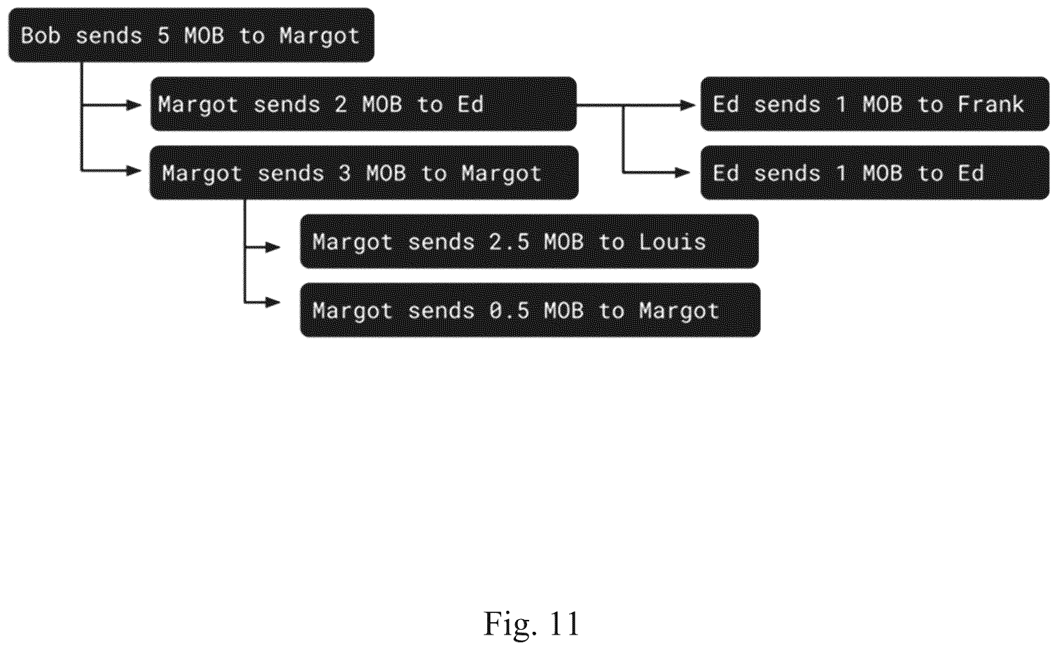

FIG. 11 illustrates an example of a Sentz™ T3 Graph.

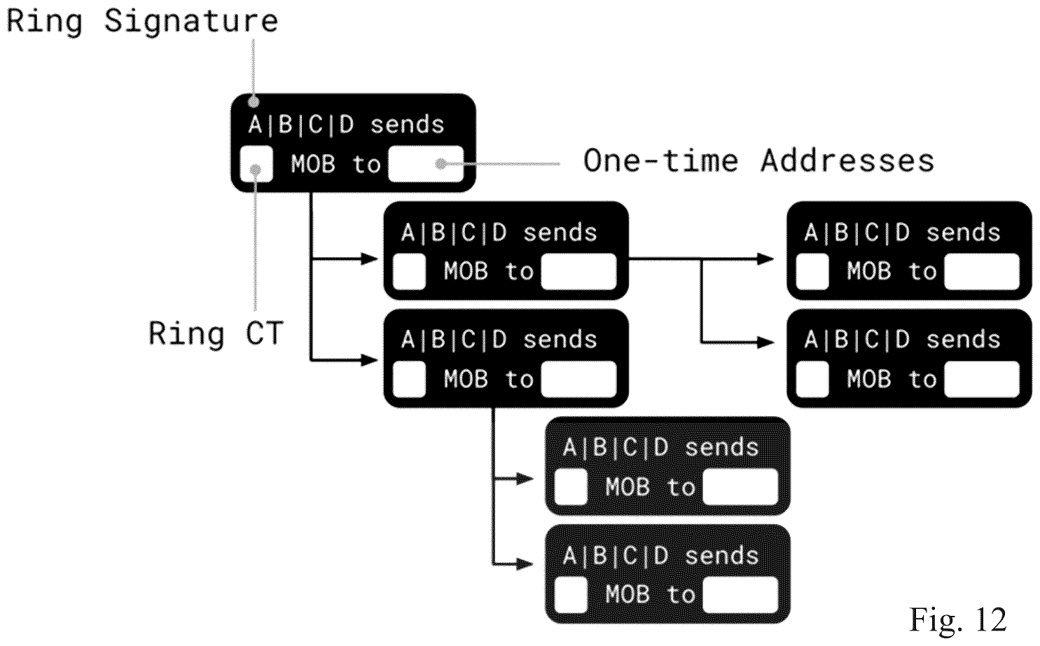

FIG. 12 illustrates an example of a Sentz™ PrivatePay Transaction Graph.

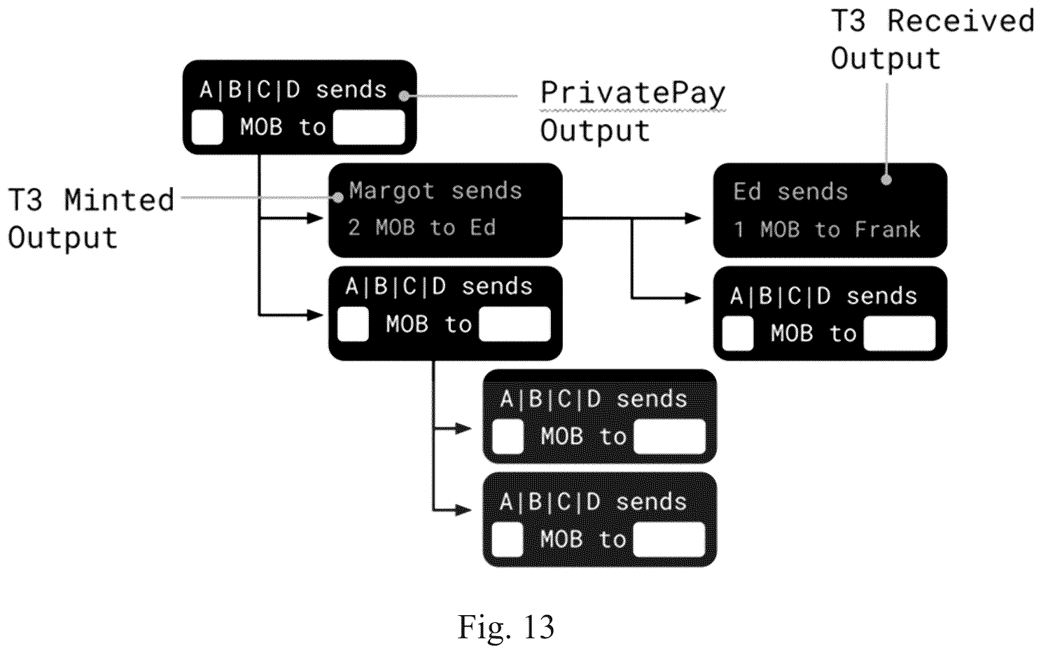

FIG. 13 illustrates an example of a Goal: A Hybrid Chain with PrivatePay+T3.

Because the inputs are not written to the chain, there is actually no linkage between any of the transactions here, even the T3 transactions, except via “pass through likability,” or during an active SGX exploit.

### T3 Sender Memo and Ring Selection

Depending on the implementation of the encrypted blockchain, the clients constructing transactions may wish to color certain outputs without changing the nature of their fungibility. For example, with a blockchain utilizing ring signatures for inputs, clients may wish to exclude T3 TxOuts. This could also be defined by the wallet implementation, for example, as the PrivatePay guarantee or with an explicit threat model stating whether or not T3 outputs may be selected for input rings. This sort of on-chain coloring also provides recoverable data (so that a client does not need to manage this state within the wallet), while also allowing permissionless, public visibility into the quantity of T3 transactions. One way to do this is to use the “unused bytes” of the encrypted memos for Recoverable Transaction History, which flags that the data in that memo, such as the authenticated hash of the of the sender's T3 address, is in the clear in a payload delivered to a wallet service.

The 46-byte layout for the T3 Sender Memo may look like the following:

| Byte | |
|---|---|
| Range | Item |
| 0-2 | Memo Type (In the clear) |
| 2-4 | Empty bytes (0x0000, to reduce |
| | collisions with encrypted memos) |
| 4-6 | RTH Sender Memo Type (e.g. |
| | 0x0100 |
| 6-20 | Sender's Address Hash |
| 20-28 | Unused bytes −> first 2 bytes |
| | indicate encrypted output (0x0000) |
| | or T3 output (0x0100) |
| 28-44 | HMAC |

When building rings, clients should avoid T3 outputs by checking the memo type of the inputs they are selecting for the rings, and only using inputs with encrypted memo types. Some services, such as Fog Ledger, may pre-filter outputs for rings to make this a lower lift for the clients. An example embodiment of the Fog Ledger referenced herein is disclosed in U.S. Pat. No. 11,989,720, titled, “SYSTEM AND METHOD FOR OBLIVIOUS INFORMATION RETRIEVAL.”

### Receiving T3 Outputs

A user receives T3 Outputs at their usual address, and the funds are not segregated in their wallet.

### T3 API Specification

In an example embodiment, the T3 API can be expressed in protobuf, which is trivial to translate and serve simultaneously as a REST endpoint.
1. Get institutional data for given addresses or blocks.

```
rpc GetT3Data (GetT3DataRequest) returns (GetT3Dataresponse);
// Request institutional data: Authenticated
message GetT3DataRequest {
  // Optional address hash for which to retrieve data
  repeated string address_hash = 1;
  // Optional transaction identifiers for which to retrieve data
  repeated string tx_pubkeys = 2;
}
message GetT3DataResponse {
  enum Result {
    RESULT_UNSPECIFIED = 0;
    RESULT_OK = 1;
  }
  Result result = 1;
  // Block data containing institutional data
  repeated T3Transaction t3_transactions = 2;
}
// T3 Transaction Data Type
message T3Transaction [
  // Address hash of the sender
  string sender_address_hash = 1;
  // Address hash of the recipient
  string recipient_address_hash = 2;
  // The token type (currency) of this transaction
  uint64 currency = 3;
  // The amount of this transaction, in the currency denoted above
  uint64 amount = 4;
  // The transaction identifier (tx_pubkey) corresponding to the TxOut in the blockchain
represented by this transaction
  external.v1.CompressedBistretto public_key = [symbol]
} [symbol]
indicates data missing or illegible when filed
```

2. Store institutional transaction data.

```
rpc storeT3Transaction (StoreT3TransactionReqest) returns (StoreT3TransactionResponse);
// Store [symbol]  T3 transaction: Authenticated
message StoreT3TransactionRequest {
  // The full T3 transaction data for this transaction
  T3Transaction t3_transaction = 1;
}
message StoreT3TransactionResponse {
  enum Result {
    RESULT_UNSPECIFIED = 0;
    RESULT_OK = 1;
  }
  Result result = 1;
} [symbol]
indicates data missing or illegible when filed
```

### Wallet Service Data Model Changes

The data model changes to add T3 data per user are shown below.

| Transaction Record | | |
|---|---|---|
| public_key | . . . | is_13(bool) |

### T3 Data Model

The T3 data model structure is shown below.

T3 Transaction

| | | | | |
|---|---|---|---|---|
| public_key | sender_address_hash | recipient_address_hash | token_id | amount |

### Institutional Wallet API Specification

In order to provide T3 data, the institution's wallet must be started with a valid T3 API key. The institutional wallet JSONRPC API now returns institutional data as a new T3Txo object (in contrast to the Txo object which is only populated for Txos owned by the wallet), and populates a reference to T3Txos via the tx_pubkey identifier in the Block:

```
pub struct T3Tx [symbol]  {
  pub tx [symbol] _index: String,
  pub tx_pubkey: String,
  pub sender_address_hash : String,
  pub recipient_address_hash: String,
  pub currency: String,
  pub amount: Vec<String>,

[symbol]

pub struct Block {
  pub id: String,
  pub version: String,
  pub parent_id: String,
  pub index: String,
  pub cumulative_tx [symbol] _count: String,
  pub root_element: [symbol] ,
  pub contents_hash: String,
  pub T3_tx_pubkeys: Vec<String>,
} [symbol]
indicates data missing or illegible when filed
```

### Institutional Wallet Data Model Changes

As the institutional wallet (with a T3 API Key provisioned by Sentz™) syncs the ledger, it determines when a sender memo is unencrypted, and builds a table of T3 data, by querying the wallet service for data from the public_key of the TxOut. The sample table is shown below.

T3 Blocks

| | | | | | |
|---|---|---|---|---|---|
| block_index | tx_pubkey | sender_address_hash | recipient_address_hash | currency | amount |

Different institutions have different risk assessments of the source of funds based on how many transparent transactions occurred prior to the output that is being spent. In this example embodiment, it is possible to mint a T3 output that has no history. Institutions must decide what level of T3 data is required to satisfy their risk requirements. This is similar to how Credit Scores work.

The clients that are constructing the transactions can choose to only pay from their PrivatePay balance, which would then only reveal the sender of the transaction, and the recipient, which is the institution. Important to note, though, is that as soon as you have two iterations of T3 transactions, there is a graph that reveals more than the last hop. This has a positive impact on the end customer when their goal is to provide a more robust risk score to access a richer feature set or higher limits from the ramp provider.

The example embodiments disclosed herein do not consider velocity. Velocity is the measurement of the amount of funds over the number of transactions. For example, a high velocity transaction may include multiple small amounts aggregated in one hop to the same address (this is an operation commonly performed to “sweep up dust,” for example). The reason we do not consider velocity is that it would require providing more than one T3 transaction at all times to interact with an institution, and this greatly reduces usability. Note that our blockchain enforces limits of 16 inputs per transaction, so aggregation or “defragmentation” operations are a basic primitive necessary for operating a wallet.

If a user has a T3 output in their history with PrivatePay transactions in between a T3 minted output, we can collapse the history to provide a coherent source of funds. For example, if a user onboards via an Onramp Institution, and is offramping via an Offramp Institution, we can eliminate the intermediary transactions and provide the Onramp Institution input for the Offramp output. This proposal does not consider this feature, and leaves it to blockchain forensics firms to create risk models with the information available.

In an example embodiment using a particular blockchain formulation, the institutional wallet may provide other compliance features, such as view-key scanning, which enables a third party to view all transactions that were received by an institution without that institution provisioning spend authority to the third party.

In the example embodiments disclosed herein, we keep the Sentz™ block format, and include the inputs and outputs as something that can span multiple blocks, with the assumption that the relationships and metadata within a single transaction are more important than the block format in adhering to existing APIs.

This makes the T3 data minimally recoverable from the blockchain paired with the wallet service's additional meta data, while making it clear which TxOuts not to use for ring selection. Note that this t3 sender address can be trivially rotated by the client deriving the next child public key from the mnemonic. Then, determining which child index the client is at is recoverable from the on-chain data by incrementing the child address for each new sender t3 address when seeing recoverable transaction history destinations in your change TxOuts corresponding to t3 sender addresses in the same block.

As T3 only stores the address hash, we do not need to distinguish between transparent and shielded addresses. Outputs are spendable in any transaction, the only care that needs to be taken is due to ring selection, discussed at length above.

One choice we could make is to only report USD amounts rather than amount+currency. Presumably this is the instantaneous value that is most interesting to institutions.

Representing the new public token type as an asset type on chain further complicates the “two balance” problem, even when we have atomic swaps in place and the ability to send heterogeneous transactions. In addition, we now need to manage liquidity for public tokens.

In addition, the ring selection problems still apply, as confidential token IDs were specifically designed to not need to categorize token types into different Merkle trees on the Fog Ledger, but we would want to mark these assets as public on chain.

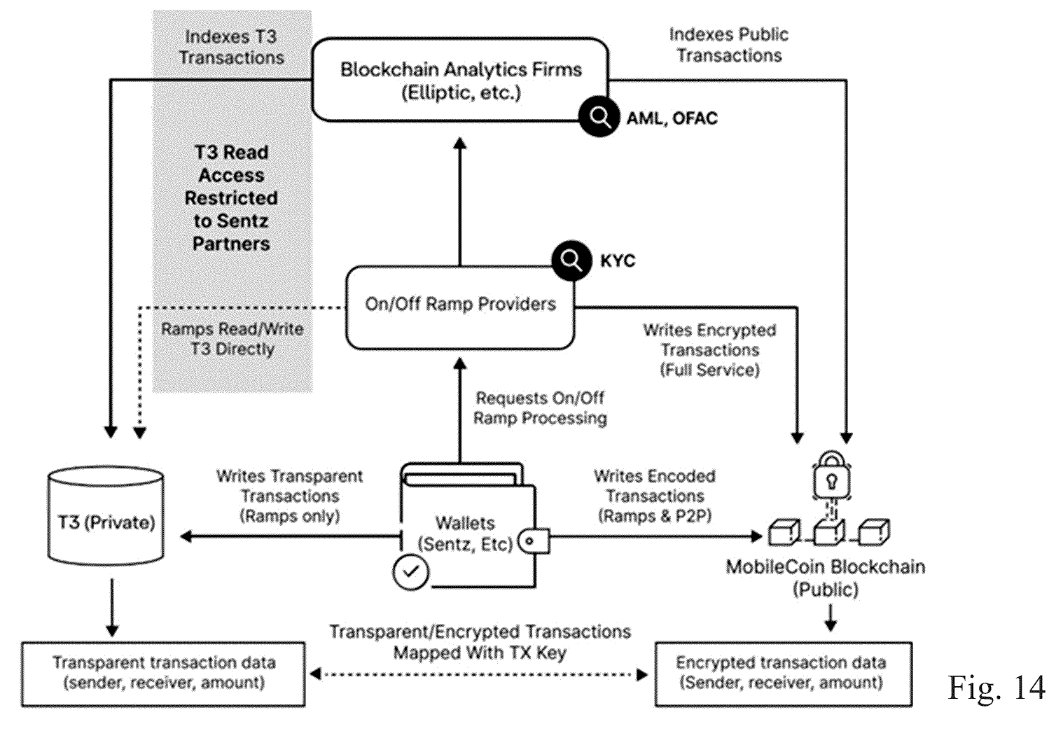

FIG. 14 illustrates an overview of the system architecture of an example embodiment. As blockchain solutions gain traction for payments use cases, a delicate balance, emerges, providing transparency for the safety of customers and institutions while also protecting user data with encryption. The unified solution provided by the disclosed example embodiments involves a trusted database where customers opt in to share transaction details unlocking access to an institution's features and products.

As disclosed in various example embodiments herein, T3 (Trusted Transparent Transactions) is an information platform which provides Business to Consumer (B2C) and Business to Business to Consumer (B2B2C) transaction data to blockchain analytics firms, data which was previously inaccessible for encrypted blockchains.

Using the capabilities of the T3 platform disclosed herein (via an API), institutions can extract opted in transactional data without breaking privacy for peer-to-peer transactions. The T3 platform can be utilized by a T3 service provider and ramp partners to report regulated transactions.

This strategic collaboration empowers financial institutions, exchanges, and any other services running on T3 to operate safely within an encrypted chain while maintaining a compliance level comparable to that on any public blockchain. FIG. 14 illustrates an example embodiment of this process.

Only the parties requiring critical transaction data can access that data from the platform. Sharing the necessary information to fulfill various regulatory requirements, without broadcasting the customers balance and transaction history with the world, protects customers and promotes security. It is worth noting that most familiar payments providers such as Venmo™, CashApp™, Paypal™ are not HIPAA compliant. This approach is something that would enable payments with the proper level of encryption to protect user data, while allowing institutions and payments providers to adjust transparency according to their business needs. T3 only tracks which wallets have interacted with specific regulated institutions or institutions that otherwise prefer a certain level of transparency for business operations, while peer-to-peer (P2P) payments remain protected with PrivatePay™. Referring again to FIG. 1, these aspects of an example embodiment are illustrated. As shown in FIG. 1, T3 reports on a subset of user transactions which interact with compliant institutions. These transparent transactions provide insights necessary to build a proprietary risk score without compromising peer to peer privacy or the end-to-end encryption of the blockchain.

In an example embodiment, Sentz™ can provide a payments protocol that is as fast and secure as a credit card, with the benefits of blockchain technology, namely global access, instant finality, and end-user control of funds. The Sentz™ technology described herein serves a variety of use cases, from peer-to-peer in a mobile app (e.g., splitting dinner) to merchant sales direct-to-consumer (e.g., buying coffee). The Sentz™ technology described herein can support multiple assets, including various types of digital assets, such as MOB and the fully backed stablecoin, eUSD.

Sentz™ wallets provide additional controls, such as enforcing phone number and IP region blocks, limiting transfer amounts, and performing node attestation. This confirms all nodes run the exact version of the software approved by the foundation, ensuring integrity for clients and nodes alike. Embedded into the blockchain protocol of an example embodiment are three proprietary compliance technologies-Authenticated Sender Memos, Receipts, and Subaddresses, as detailed below.

### 1. Authenticated Sender Memos

Transactions include a cryptographically authenticated sender identification so that the recipient can be certain the funds were received from whoever controls that sender account. This data is included in every transaction and is recoverable from the blockchain with the sender or receiver's private keys.

### 2. Receipts

A Receipt send provides verification of the source of funds. Wallets can opt-in to generate receipts for every transaction (every Signal transaction generates a receipt).

These are off-chain and can be shared with the counterparty or with any party who needs to verify the sender of the transaction. The unique payment identifier (UPI) can only be delivered by the person who initiated the transaction and cannot be forged by a third party. The Receipt offers cryptographic proof the creator has information only known at the formation of the transaction.

### 3. Subaddresses

Institutions employ sub-addresses so that a specific address is sequestered for each transaction. This provides linkages from the transaction to a party and allows for an extremely high degree of certainty the transaction belongs to the person allocated the address. No other payment coin has all these features.

T3 emphasizes responsible third-party custodianship of transaction data.

Institutional compliance programs require transparent details about transactions with their counterparties. T3 reveals the Sender, Receiver, and amount of transactions to trusted third parties. This is in contrast to our PrivatePay™ transactions, in which the Sender, Receiver, and Amount are revealed only to the counterparty rather than shared with trusted third parties, such as blockchain forensics providers.

All Sentz™ wallets submit transparent transaction data to a trusted database when they send or receive digital assets (e.g., eUSD) with an institution. Institutions opt-in to send transparent data when they send or receive a transaction from a user. This service can be managed by Sentz™ (or other T3 service provider) and can be replicated (so, for example, a card processor could run its own T3 instance). The T3 platform disclosed herein provides read and write access to institutions that provision an API key with the T3 platform.

The T3 platform disclosed herein enables users to control their own data, and who they share it with. Cryptocurrency regulations, such as MiCA, emphasize customer control of funds and data. Data privacy regulations on the internet-starting with Article 29, evolving to Safe Harbor, then Privacy Shield, will require that there be no global payments system without protecting customer data.

In an example embodiment, Sentz™ transaction cryptography involves two private keys: a spend key and a view key. The View Key can be used to view all transactions ever received, while the spend key is required to construct new transactions. A user can provide their view key to any third party without giving up spend authority over their funds.

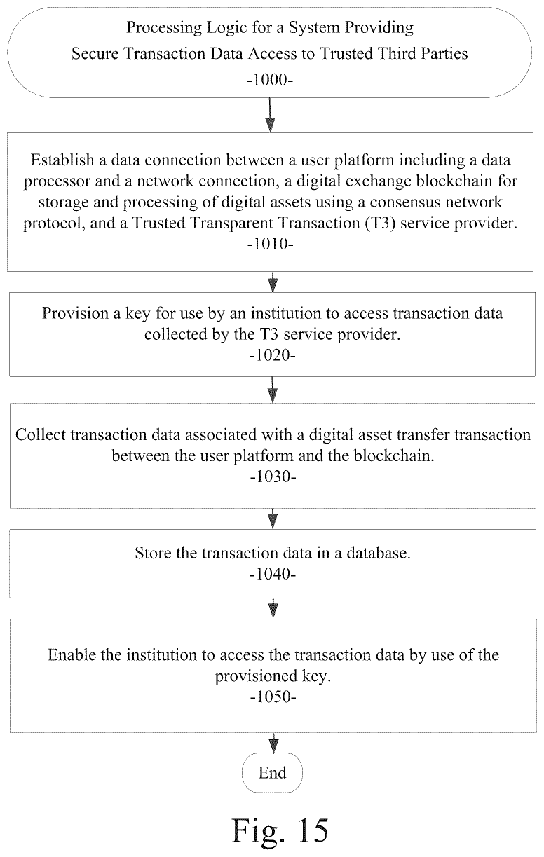

FIG. 15 is a processing flow diagram that illustrates an example embodiment of a system and method as described herein. Referring now to FIG. 15, a processing flow diagram illustrates an example embodiment of a method implemented by systems as described herein.

The system and method 1000 of an example embodiment is configured to: establish a data connection between a user platform including a data processor and a network connection, a digital exchange blockchain for storage and processing of digital assets using a consensus network protocol, and a Trusted Transparent Transaction (T3) service provider (processing block 1010); provision a key for use by an institution to access transaction data collected by the T3 service provider (processing block 1020); collect transaction data associated with a digital asset transfer transaction between the user platform and the blockchain (processing block 1030); store the transaction data in a database (processing block 1040); and enable the institution to access the transaction data by use of the provisioned key (processing block 1050).

As described herein for various example embodiments, a system and method that provide a combination of encrypted blockchain-accessible digital assets plus additional transparent compliant tooling, which can be used to provide transparent T3 transactions when users interact with institutions or when otherwise provided by the user or their wallet service is disclosed. In the various example embodiments described herein, a computer-implemented tool or software application (app) as part of an automated encrypted blockchain system is described to automate and improve the collection, transfer, and storage of T3 data related to parties in an automated financial transaction process. The disclosed embodiments enable self-custody, decentralization, and end-to-end encryption (E2EE), while pairing these features with compliance tools, technologies, and processes to create a unique T3 transaction and payment technology. As such, the various embodiments as described herein are necessarily rooted in computer and network technology and serve to improve these technologies when applied in the manner as presently claimed. In particular, the various embodiments described herein improve the use of data processing technology and data network technology in the context of an automated encrypted blockchain system implemented via electronic means.

The table below defines some of the acronyms used in this document.

Glossary

| Term | Acronym | Definition |
|---|---|---|
| Application | API | Set of defined rules that allows applications to communicate |
| Programming | | with each other |
| Interface | | |
| Hash-Based | HMAC | Cryptographic primitive for authentication of data. |
| Message | | |
| Authentication | | |
| Code | | |
| Know Your | KYC | Guidelines and regulations for institutions to verify the |
| Customer | | identities of their customers. As a verb, we refer to the act of |
| | | scanning the user's ID, or otherwise collecting identifying |
| | | information about them. |
| Know Your | KYT | Guidelines to verify details about transactions, including |
| Transaction | | source of funds and destination. |
| Liquidity | LP | A liquidity provider is an institution that lists Sentz ™ assets on |
| Provider | | ramp provider platforms or provides SentzTM assets in liquidity |
| | | pools, to facilitate liquidity for end users to exchange assets |
| | | (while onramping or offramping into/from the app) |
| Sentz ™ | MCIP | Proposals for modifications to the blockchain protocol. |
| Improvement | | |
| Proposal | | |
| Sentz ™ (Token) | MOB | The Sentz ™ asset on the Sentz ™ blockchain |
| Moby | MTH | Similar to RTH, but specific to Moby, and mediated via Twix |
| Transaction | | rather than the blockchain. |
| History | | |
| Product | PRD | Specification for product requirements |
| Requirements | | |
| Document | | |
| Recoverable | RTH | Mechanism to store sender and receiver information encrypted |
| Transaction | | as metadata on the blockchain. |
| History | | |
| Read Access | R access | Specifying type of access to a database, or permissions for an |
| | | API key. Read means only querying data is permitted, not |
| | | appending new data. |
| Read/Write | RW | Specifying type of access to a database, or permissions for an |
| Access | access | API key. Read/Write means both querying data and appending |
| | | new data are permitted. |
| Suspicious | SAR | Report by a financial institution, required by various laws and |
| Activity Report | | regulations for certain threshold conditions. |
| Secure Guard | SGX | Intel's secure enclave technology. |
| Extensions | | |
| Trusted | T3 | Service to provide transaction metadata to trusted third parties |
| Transparent | | |
| Transactions | | |
| Twix | | The backend service for Moby. A simple application with a |
| | | postgres database and grpe API. |
| Transaction | TxOuts or | The Sentz ™ blockchain is a “UTXO” blockchain, and we use |
| Outputs | Txos | “TxOuts” to refer to outputs, whether spent or not on the |
| | | Sentz ™ blockchain. |
| Transaction | tx_pubkey | The data within a transaction that uniquely identifies the |
| Public Key | | transaction, and serves several cryptographic purposes with the |
| | | users' private and public keys in order to send and receive |
| | | funds or encrypt additional metadata (such as for Recoverable |
| | | Transaction History) |
| Unspent | UTXO | A blockchain ledger design primitive. |
| Transaction | | |
| Output | | |
| User Experience | UX | Set of interfaces that the user interacts with while using the |
| | | application |
| View Key | view_key | Cryptographic key, as part of public key cryptography, |
| | | referring to the public or private component of the view_key. |
| | | The view_key allows the viewing of received transactions, in |
| | | contrast with the spend_key, which allows spending TxOuts. |
| Zero Knowledge | zk proof | A cryptographic primitive for proving a statement is true |
| Proof | | without revealing the contents of the statement. |

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen the various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the claims are hereby incorporated into the Detailed Description, with each claim standing on its own as a separate embodiment.

What is claimed is:

1. A Trusted Transparent Transaction (T3) system comprising:
a user platform including a data processor and a network connection;
a digital exchange blockchain for storage and processing of digital assets using a consensus network protocol; and
a T3 service provider configured to:
provision a key for use by an institution to access transaction data collected by the T3 service provider;
collect transaction data associated with a digital asset transfer transaction between the user platform and the blockchain;
store the transaction data in a database; and
enable the institution to access the transaction data by use of the provisioned key.

2. The Trusted Transparent Transaction (T3) system of claim 1 wherein the institution includes an offramp provider involved in depositing a digital asset with the institution.

3. The Trusted Transparent Transaction (T3) system of claim 1 wherein the institution includes an onramp provider involved in withdrawing a digital asset from the institution.

4. The Trusted Transparent Transaction (T3) system of claim 1 wherein the digital asset transfer transaction includes a transaction between the user platform and a wallet service.

5. The Trusted Transparent Transaction (T3) system of claim 1 wherein access to the transaction data by the institution is enabled only when the user platform opts in.

6. The Trusted Transparent Transaction (T3) system of claim 1 wherein the stored transaction data is discernible from transaction output data stored on the blockchain.

7. The Trusted Transparent Transaction (T3) system of claim 1 wherein the provisioned key is an Application Programming Interface (API) key.

8. The Trusted Transparent Transaction (T3) system of claim 1 wherein the T3 service provider stores a public key (tx_pubkey) associated with the digital asset transfer transaction.

9. The Trusted Transparent Transaction (T3) system of claim 1 wherein the stored transaction data includes a sender hash address, a recipient address hash, a token, an amount, and a transaction identifier.

10. The Trusted Transparent Transaction (T3) system of claim 1 wherein the T3 service provider stores a common conversion valuation of an amount corresponding to the digital asset transfer transaction.

11. The Trusted Transparent Transaction (T3) system of claim 1 wherein the digital asset transfer transaction includes a cryptographically authenticated sender identification enabling a recipient to validate that digital assets were received from an appropriate sender account.

12. The Trusted Transparent Transaction (T3) system of claim 1 wherein a receipt is generated for the digital asset transfer transaction.

13. The Trusted Transparent Transaction (T3) system of claim 1 wherein the institution employs sub-addresses to sequester a specific address for each transaction.

14. A method comprising:
establishing a data connection between a user platform including a data processor and a network connection, a digital exchange blockchain for storage and processing of digital assets using a consensus network protocol, and a Trusted Transparent Transaction (T3) service provider;
provisioning a key for use by an institution to access transaction data collected by the T3 service provider;
collecting transaction data associated with a digital asset transfer transaction between the user platform and the blockchain;
storing the transaction data in a database; and
enabling the institution to access the transaction data by use of the provisioned key.

15. The method of claim 14 wherein the institution includes an offramp provider involved in depositing a digital asset with the institution.

16. The method of claim 14 wherein the institution includes an onramp provider involved in withdrawing a digital asset from the institution.

17. The method of claim 14 wherein the digital asset transfer transaction includes a transaction between the user platform and a wallet service.

18. The method of claim 14 wherein access to the transaction data by the institution is enabled only when the user platform opts in.

19. The method of claim 14 wherein the stored transaction data is discernible from transaction output data stored on the blockchain.

20. The method of claim 14 wherein the provisioned key is an Application Programming Interface (API) key.
